(19) United States
(12) Patent Application Publication
(10) Pub. No.: US 2021/0163258 A1
(43) Pub. Date: Jun. 3, 2021

(54) ELEVATOR CONTROL CABINET WITH A VOICE COMMUNICATIONS APPARATUS AND METHOD FOR MONITORING A CABINET DOOR

(71) Applicant: Inventio AG, Hergiswil (CH)

(72) Inventors: Frank Olivier Roussel, Luzern (CH); Stefano Carriero, Cham (CH)

(21) Appl. No.: 17/250,471

(22) PCT Filed: Jul. 3, 2019
(86) PCT No.: PCT/EP2019/067828

§ 371 Date: Jan. 26, 2021

(30) Foreign Application Priority Data
Jul. 26, 2018 (EP) 18185803.6

(51) Int. Cl. B66B 5/00; B66B 5/02; G08B 23/00; G08B 3/10

(52) U.S. Cl. CPC B66B 5/0018; B66B 5/021; B66B 2201/23; G08B 3/10; G08B 23/00

(57) ABSTRACT

An elevator control cabinet used in an elevator system includes a voice communication apparatus having a microphone, an electronic control arrangement, an evaluation unit, and a cabinet housing having at least one cabinet door. The voice communication apparatus is used to execute a service or emergency call or establish a communication between the elevator and a public communication network. The microphone detects a surrounding noise in the control cabinet. The evaluation unit converts the detected noise into a noise pattern and then compares this noise pattern with a reference sound pattern that is predetermined for a surrounding noise in the cabinet housing with the open or closed cabinet door. This reference sound pattern is saved in a storage unit of the control arrangement. In dependence on a result of the comparison, the evaluation unit will recognize whether the cabinet door is open or closed.

### FIELD

The invention relates to an elevator control cabinet with a voice communication apparatus, an elevator system comprising such a control cabinet and a method for monitoring a cabinet door.

### BACKGROUND

An electric control system of an elevator consists generally of at least a controller, an operating device, a leveling device, a power supply, communication devices, switches and other components. Most of these devices and components are put and integrated into a so-called control cabinet or controller cabinet. Such a control cabinet is normally set in a machine-room (MR) or located on a wall near a shaft door on the bottom floor or top floor for a machine-room-less (MRL) elevator.

For an installation, a maintenance or an inspection working, a technician usually has to open a door of the control cabinet and operate the components and devices inside of this control cabinet to control the elevator. Sometimes the technician needs to repair or exchange one or more of these components or devices. After the work, the cabinet door has to be closed again, so that the control cabinet and its components are not accessible for persons who are not authorized to operate with this cabinet. For this reason, such a control cabinet comprises a door contact sensor to detect whether the cabinet door is open or closed. Then the door contact sensor will tell a security system or a control unit about the detected status of the door in order to trigger an alarm signal. Door contact sensors or the like are known in many forms. An available door contact sensor is normally constructed e.g. in two parts, one part is installed on the door while the other piece is fixed on the door jamb or frame.

But wear and environment pollution seriously influences the reliability of electric contacts. Failures of electric devices or elements are closely related to this problem. Electric contact and electrical characteristics are also strongly dependent on dust, water, oil etc. For example, dust contamination is a major cause of current disruption in electric contacts. Effective ways to reduce the failure caused by fine dust particles still present a difficult and unsolved problem.

### SUMMARY

One object of an embodiment may be to optimize a door monitoring of an elevator control cabinet and to increase the access security of this control cabinet.

Such an object may be achieved by the subject-matter of the exemplary embodiments in the following description.

According to the present invention, a control cabinet for an elevator comprises a voice communication apparatus having a microphone, an electronic control arrangement, an evaluation unit, and a cabinet housing and at least one cabinet door. The electronic control arrangement is intended for controlling the elevator. The voice communication apparatus is provided e.g. to execute a service or emergency call or establish a communication between the elevator and a public communication network. And the microphone of this voice communication apparatus is able to detect a surrounding noise in the control cabinet. And the evaluation unit is so configured that it can convert the detected noise into a noise pattern and then compare this noise pattern with a reference sound pattern which is predetermined for a surrounding noise in the cabinet housing with the open or closed cabinet door. This reference sound pattern is saved in a storage unit of the control arrangement. In dependence on a result of the comparison, the evaluation unit will recognize a door status of the cabinet door whether it is open or closed. Then a control cabinet including the components and devices inside can be more safely protected. As the access security of the control cabinet is increased, the safety of an elevator will be also improved.

The invention is beneficial in that the microphone in the cabinet is used as a door sensor. The microphone acts here as an interface between a sound field and a measuring system. It transfers sound pressure oscillations in the air into electrical signals. The microphone can be of the following types: piezoelectric, condenser, electret or dynamic microphone or other varieties like MEMS (microelectromechanical system), ribbon, carbon, fiber optic, laser as well as a speaker as a microphone. The most common one is the piezoelectric microphone, whereat a membrane (not illustrated) is attached to a piezoelectric crystal which generates an electric current when submitted to mechanical tension. The air vibrations resulting from the sound waves are picked up by the microphone membrane, and the resulting pressure on the piezoelectric crystal transforms the vibration into an electric signal. Because the microphone is integrated in the voice communication apparatus and could be located away from the cabinet door, the microphone is thus much less prone to dust, water, rust, oil, chemical pollution and any other pollution caused by a sudden or gradual process to a normal electric door contact sensor.

The electronic, electric and electro-mechanical devices or elements in the control cabinet are composed of various noise sources such as relays, fans, transformers, converters, processing units, etc. As a sound pressure depends on environment, structure and material of reflecting surface, distance, ambient sounds, and so on, so that a sound or a noise detected by the microphone must be different in the case when the cabinet door is closed or opened. By taking advantage of this physical phenomenon, the status of the cabinet door can be determined. Therefore, a door sensor is no longer necessary. This can save construction costs and enhance the accuracy of the door monitoring. In the meanwhile, the service access security of the elevator can be better ensured, as it will be prevented that the cabinet with an open door is accessible for an authorized person. This monitoring possibility of the cabinet door can be also used to detect a technician's visiting and her/his attendance so that it is able to determine whether the technician has left the elevator or the service working is finished completely.

As an improvement of the present invention, the control arrangement comprises a control unit, and the evaluation unit reports the detected door status to this control unit. The control unit could be a main control for the elevator or is only responsible for this control cabinet. The voice communication apparatus comprises further a loudspeaker which is activatable by the control unit to generate an alarm signal. For example, the alarm signal is an acoustic and/or optical signal and will be generated when the cabinet door stays still open after a certain time and/or according to a status of a certain switch, e.g. an emergency switch or an operating switch.

As a further improvement of the present invention, the elevator can be set in a service (installation/inspection/maintenance) mode and a normal operation mode. The control unit can activate the loudspeaker in relation to an operation mode of the elevator, wherein the loudspeaker generates the alarm signal when the elevator is set in a normal operation mode and the cabinet door is open and/or when the elevator is set in a service mode and the cabinet door is closed. Advantageously, the loudspeaker will generate the alarm signal in a predetermined time period (e.g. three minutes) after detecting the status (closed or open) of the cabinet door and/or the operation mode (service mode or normal operation mode) of the elevator.

As a further improvement of the present invention, the electronic control arrangement comprises a noise producing element for generating a defined surrounding noise which can be used to determine whether the cabinet door is open or closed. With the help of the additionally generated noise the detection of the door status is also possible, when the environmental noise level is very low. Optionally, the loudspeaker of the voice communication apparatus can be used as a noise producing element.

As a further improvement of the present invention, the electronic control arrangement comprises further an electronic power unit which is connectable with an electromotor to drive a car of the elevator. The electronic power unit can disconnect the electromotor from its power supply when the loudspeaker generates an alarm signal, then the elevator car will be stopped and can't move anymore.

As an improvement of the present invention, the voice communication apparatus is an elevator intercom system. An intercom (also called as tele-alarm) connects passengers, technicians, and safety facilities independent from a public network like telecommunication network, e.g. PSTN (Public Switched Telephone Network) and is applied to elevator emergency or overhauling. A typical using of intercom is e.g. to establish a communication between a machine room and an elevator car.

Furthermore advantageously, the control cabinet can be disposed in a machine room, in and/or outside of a hoistway of the elevator, e.g. inside of an elevator car, on the car roof or on the bottom of the hoistway.

According to other embodiments, an elevator system comprises a control cabinet according to the afore-described one embodiment.

According to other embodiments, a method monitors a cabinet door status of a control cabinet which comprises a voice communication apparatus having a microphone, an electronic control arrangement to control the elevator, an evaluation unit, a cabinet housing and at least one cabinet door. The method comprising the steps of:
detecting a surrounding noise in the control cabinet by the microphone,
converting this detected surrounding noise into a noise pattern and comparing this noise pattern with a predetermined reference sound pattern by the evaluation unit, wherein the reference sound pattern is determined from a surrounding noise in the cabinet housing with a defined cabinet door status, and
determining a door status of the cabinet door whether this cabinet door is open or closed.

Optionally, a loudspeaker of a voice communication apparatus can be activated by the control unit in relation to an operation mode of the facility to generate an alarm signal when the facility is set in a normal operation mode and the cabinet door is open and/or when the facility is set in a service mode and the cabinet door is closed.

Optionally, the loudspeaker is activated to generate the alarm signal after a predetermined time period when the cabinet door has been closed or opened and/or when the facility has been changed its operation mode.

Optionally, a predefined surrounding noise is generated by a noise producing element or by the loudspeaker of the voice communication apparatus. With the help of the additionally generated noise, the detection of the door status is also possible, when the environmental noise level is very low.

Other technological benefits of the present invention become evident to a person skilled in the art from the following description and the claims. The numerous examples of implementing the present invention achieve only a part of the presented advantages. None of the advantages is critical to the examples of implementation. Any required embodiment can technically be combined with any other required embodiment. The examples represent only a few advantageous embodiments and they do not limit the idea of the invention that can be implemented even in other manners within the framework of the claims presented further below.

### DESCRIPTION OF THE DRAWINGS

The above, as well as other advantages of the present invention, will become readily apparent to those skilled in the art from the following detailed description of a preferred embodiment when considered in the light of the accompanying drawing in which:

FIG. 1 illustrates a perspective view of a control cabinet for an elevator according to the invention.

### DETAILED DESCRIPTION

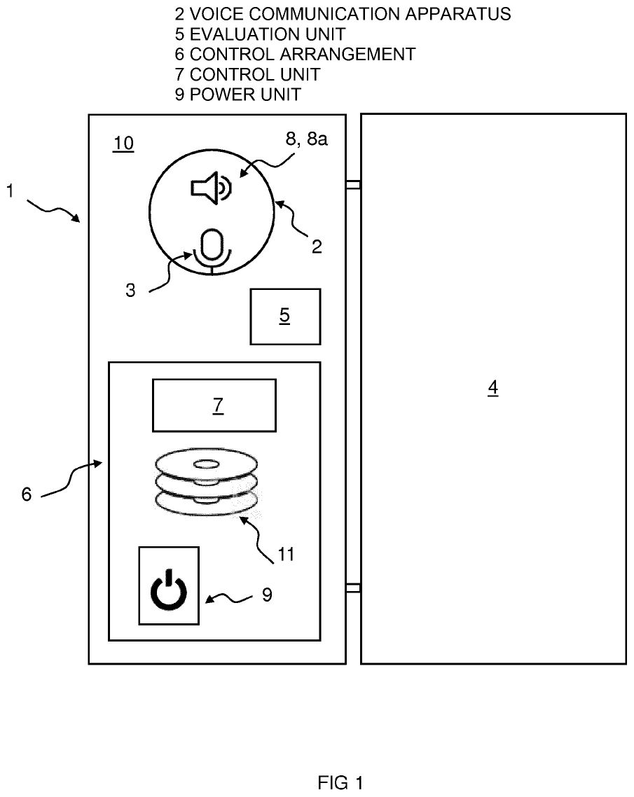

FIG. 1 illustrates a control cabinet 1 constructed in accordance with the present disclosure. This control cabinet 1 can be installed for an elevator (not illustrated) in a machine room, at an elevator car, in and/or outside of a hoistway, for example, in a hoistway door frame or in a wall on the floor. In one elevator there could be one or more control cabinets available. In a cabinet housing 10 of this control cabinet 1 there is a voice communication apparatus 2, e.g. intercom system. The elevator Intercom system is applied to such as elevator emergency or service application. This voice communication apparatus 2 comprises a microphone 3 and a loudspeaker 8 which can provide audible sounds as well as a buzzing sound. The microphone 3 is for instance a piezoelectric microphone. Besides the voice communication apparatus 2 there are an electronic control arrangement 6 and on demand also other devices or components inside of the cabinet housing 10, wherein the control arrangement 6 comprises further a control unit 7, an evaluation device 5 and an electronic power unit 9. The electronic power unit 9 is connectable with an electromotor (not illustrated) which is as a drive motor for the elevator.

These electric and electronic devices and components in the cabinet 1 make various noises because of their operations like switching, venting or vibrations resulted by electromagnetic fields and so on. The microphone 3 as a sound sensor captures these surrounding noises and transfers them into electrical signals, wherein the noises can be characterized e.g. by frequency spectrum, amplitude distribution and the physical mechanism that generates it. Therefore, it is possible to analyze and evaluate a noise pattern based on these detected noises.

The cabinet housing 10 can be closed and locked with a cabinet door 4. As the cabinet's acoustic properties are related to the housing's size, shape, material, surface absorption and ambient or background noise etc., so that the noises detected by the microphone 3 are different when the cabinet door 4 is closed or opened. The evaluation unit 5 can convert the detected noise into a noise pattern and then compare this noise pattern with at least one reference sound pattern. The reference sound patterns are predetermined based on a surrounding noise detected in the cabinet housing 10 with the open and/or closed cabinet door 4 respectively and saved in a storage unit 11 of the control arrangement 6. According to a result of the comparison, the evaluation unit 5 will recognize a door status of the cabinet door 4 whether it is open or closed.

The evaluation unit 5 reports then the detected door status to the control unit 7. The control unit 7 may be responsible for the elevator or only for this control cabinet 1. The control unit 7 will actuate the loudspeaker 8 to generate an alarm signal when e.g. the cabinet door 4 still stays open for a certain time after an inspection working is already finished or an operation mode switch has been switched from a service mode to a normal operation mode. This means that the control unit 7 won't actuate the loudspeaker 8 and may ignore the case if the door 4 has been opened and shortly subsequently “closed” again. On the contrary, the alarm signal is generated when the elevator has been set in the service mode and the cabinet door 4 is closed. The electronic power unit 9 of the control arrangement 6 can disconnect the electromotor from its power supply when the alarm signal is generated. Then the elevator car of the elevator can no more move.

Sometimes it would happen that the evaluation unit 5 can not identify whether the door 4 is open or closed, when the detected environmental noise level is very low or the background noise is too high. For this case, the loudspeaker 8 can act as a noise producing element 8a to simulate and generate a predefined surrounding noise which can be saved in the storage unit 11 too. The microphone 3 will detect this simulated surrounding noise, with the same procedure as described above, and it can be detected whether the door status currently is open or closed.

Such a measure intends to alert a technician to an unsafe condition if she/he has been forgetting to close the cabinet door 4 after an inspection work. Although when the cabinet door 4 is closed, but the elevator is still in a service mode, it may generate an alarm signal, this will prevent that a device or an element perhaps has been forgotten to switch back to its original state. It is also helpful for reminding the technician to check the control cabinet 1 again.

It is obvious to a person skilled in the art that with the advancement of technology, the basic idea of the invention may be implemented in various ways. The invention and its embodiments are thus not limited to the examples described above; instead they may vary within the scope of the claims. Finally, it should be noted that terms such as “comprising” do not exclude other elements or steps and that terms such as “a” or “an” do not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SYMBOLS

1 Control cabinet
2 Voice communication apparatus
3 microphone
4 cabinet door
5 evaluation unit
6 control arrangement
7 control unit
8 loudspeaker
8a noise producing element
9 power unit
10 cabinet housing
11 storage unit

1-15. (canceled)

16. A control cabinet for an elevator, the control cabinet comprising:
a cabinet housing having a cabinet door, the cabinet door being movable between an open position providing access to an inside of the cabinet housing and a closed position preventing access to the inside of the cabinet housing;
a voice communication apparatus having a microphone;
an electronic control arrangement to control the elevator;
an evaluation unit;
wherein the voice communication apparatus, the electronic control arrangement and the evaluation unit are positioned inside the cabinet housing;
wherein the microphone detects a surrounding noise inside the cabinet housing;
wherein the evaluation unit converts the detected surrounding noise into a noise pattern and compares the noise pattern with a predetermined reference sound pattern, the reference sound pattern being determined from a surrounding noise in the cabinet housing associated with a door status of the cabinet door, the reference sound pattern being saved in a storage unit of the electronic control arrangement; and
wherein the evaluation unit recognizes the door status of the cabinet door as being open or closed in response to the comparison of the noise pattern with the predetermined reference sound pattern.

17. The control cabinet according to claim 16 wherein the control arrangement includes a control unit and the evaluation unit reports the recognized door status of the cabinet door to the control unit.

18. The control cabinet according to claim 17 wherein the voice communication apparatus includes a loudspeaker and the control unit activates the loudspeaker to generate an alarm signal.

19. The control cabinet according to claim 18 wherein the control unit activates the loudspeaker in relation to an operation mode of the elevator such that the loudspeaker generates the alarm signal when at least one the elevator is set in a normal operation mode and the cabinet door is open and when the elevator is set in a service mode and the cabinet door is closed.

20. The control cabinet according to claim 18 wherein the control unit activates the loudspeaker to generate the alarm signal a predetermined time period after the cabinet door has been closed or opened and an operation mode of the elevator changes.

21. The control cabinet according to claim 18 wherein the electronic control arrangement includes an electronic power unit connectable with an electromotor, wherein the electronic power unit can disconnect the electromotor from a power supply when the alarm signal is generated.

22. The control cabinet according to claim 16 including a noise producing element for generating a predefined surrounding noise.

23. The control cabinet according to claim 22 wherein the loudspeaker is the noise producing element that generates the predefined surrounding noise.

24. The control cabinet according to claim 16 wherein the voice communication apparatus is an elevator intercom system.

25. The control cabinet according to claim 16 wherein the control cabinet is disposed in one of a machine room, in a hoist way and outside a hoistway of the elevator.

26. A method for monitoring a status of the cabinet door of the control cabinet according to claim 16 wherein the voice communication apparatus includes a loudspeaker, the method comprising the steps of:
detecting a surrounding noise in the control cabinet with the microphone;
converting the detected surrounding noise into a noise pattern and comparing the noise pattern with a predetermined reference sound pattern using the evaluation unit, wherein the reference sound pattern is determined from a surrounding noise in the cabinet housing associated with a door status of the cabinet door; and
determining the door status of the cabinet door as being open or closed based upon the comparing.

27. The method according to claim 26 further comprising the steps of:
activating the loudspeaker of the voice communication apparatus in relation to an operation mode of an elevator associated with the control cabinet; and
generating an alarm signal at least one of when the elevator is set in a normal operation mode and the cabinet door is open and when the elevator is set in a service mode and the cabinet door is closed.

28. The method according to claim 27 further comprising the step of activating the loudspeaker to generate the alarm signal a predetermined time period after the cabinet door has been closed or opened and the operation mode of the elevator changes.

29. The method according to claim 26 further comprising the step of generating a predefined surrounding noise with a noise producing element in the cabinet housing or with the loudspeaker.

30. An elevator system comprising:
the control cabinet according to claim 16; and
an elevator connected to the electronic control arrangement in the control cabinet.
